(19) United States
(12) Patent Application Publication
(10) Pub. No.: US 2018/0108031 A1
(43) Pub. Date: Apr. 19, 2018

(54) METHOD OF MAKING A PAYMENT AND LOYALTY TRANSACTION FOR GOODS AND/OR SERVICES BEING PURCHASED BY A CONSUMER FROM A MERCHANT

(71) Applicant: MasterCard International Incorporated, Purchase, NY (US)

(72) Inventors: Richard John Jones, Matraville (AU); Mike Rowe, Sydney (AU); Raphael Mueller, Maroubra (AU); Selvavinayagam Aravinthan, Westmead (AU)

(21) Appl. No.: 15/782,983

(22) Filed: Oct. 13, 2017

(30) Foreign Application Priority Data
Oct. 14, 2016 (SG) 10201608635P

(51) Int. Cl. G06Q 30/02; G06Q 20/20; G06Q 20/36

(52) U.S. Cl. CPC G06Q 30/0226; G06Q 20/204; G06Q 20/3278; G06Q 30/0238; G06Q 20/36

(57) ABSTRACT

A method of making a payment and loyalty transaction for goods and/or services being purchased by a consumer from a merchant, the method being executed by one or more processors of a mobile computer device in communication with data storage, a display and input devices.

### CROSS-REFERENCE TO RELATED APPLICATION

This application is a U.S. National Stage filing under 35 U.S.C. § 119, based on and claiming benefit of and priority to SG Patent Application No. 10201608635P filed Oct. 14, 2016.

### TECHNICAL FIELD

The present invention relates to a method of making a payment and loyalty transaction for goods and/or services being purchased by a consumer from a merchant.

### BACKGROUND OF THE INVENTION

Many people who own credit cards also participate in one or more loyalty programs. The following steps are typically performed during a transaction to claim the relevant loyalty points:
(a) the sales person rings up a total for the goods and/or services being purchased;
(b) the purchaser presents his or her loyalty card to the sales person who scans it with the merchant's point of sale (POS) system;
(c) the purchaser presents his or her credit card to the sales person who effects the transaction using the merchant's POS system; and
(d) the details of the transaction are sent to the relevant loyalty program system, which, in turn, updates the purchaser's points balance.

In more recent times, this process has been improved with use of mobile digital wallets to obviate then need for a physical credit card to be used during a credit transaction. However, the purchaser still needs to have in his or her possession the physical loyalty card to be scanned or swiped by the sales person so that he or she can claim the relevant points. As such, the advantage gained by using a mobile wallet is, somewhat, lost by still needing to produce a physical loyalty card to claim loyalty points.

It can be difficult to find the relevant loyalty card at the time of payment. This can lead to:
(a) slowing down the purchase process whilst the purchaser rummages through his or her wallet, purse or handbag;
(b) reduced user experience and, hence, a disincentive to continue to use the program;
(c) not finding the card at the time of completing a transaction which can lead to:
   (i) missing out on loyalty points; and/or
   (ii) frustration and embarrassment.

For the above reasons and more, some credit card owners choose not to participate in loyalty programs. Simply, it can be too much of a hassle to carry a card and presenting it at the point of sale.

The use of loyalty cards can not only adversely effect purchaser. Rather, merchants can also experience difficulties and inefficiencies during the sales process. For example, the transaction process in a busy café can be significantly slowed down when the purchaser is hunting for his or her loyalty card at the point of sale. This can frustrate customers waiting in the queue for service and potentially result in loss of sale.

Customers may not see the benefit of loyalty program participation at the time of the transaction because they have limited visibility of how many points they earned as part of the transaction and what their current points balance is. This can reduce the return on loyalty investment because communication of points earned from the desired behaviour takes place some time after the desired behaviour (i.e. the purchase) occurs. That is, purchaser is not immediately aware of the points that he or she has earned from the transaction and, as such, the merchant is not getting maximum benefit from those points. There is no encouragement for spending more to get more points.

It is generally desirable to provide a system that allows customers or merchants to process loyalty identification and payment as part of a single transaction.

It is generally desirable to display real time notification of points earned/updated points balance immediately after a transaction is processed.

It is generally desirable to overcome or ameliorate one or more of the above mentioned difficulties, or at least provide a useful alternative.

### SUMMARY OF THE INVENTION

In accordance with the invention, there is provided a method of making a payment and loyalty transaction for goods and/or services being purchased by a consumer from a merchant, the method being executed by one or more processors of a mobile computer device in communication with data storage, a display and input devices, including the steps of:
(a) generating a list of registered loyalty programs and receiving a consumer selection of one of said loyalty programs;
(b) generating a list of registered payment cards and receiving a consumer selection of one of said payment cards;
(c) sending payment data to the merchant's point of sale (POS) system including:
   (i) data representing said one of the selected loyalty programs; and
   (ii) data representing said one of the selected payment cards;
(d) receiving payment transaction data from the merchant POS system including:
   (i) data representing that the payment transaction was completed; and
   (ii) data representing loyalty points earned from said one of the selected loyalty programs as a result of the completed payment transaction;
(e) generating data for display on the device, including:
   (i) data representing that the payment transaction was completed; and
   (ii) data representing loyalty points earned from said one of the selected loyalty programs as a result of the completed payment transaction.

Preferably, the payment card is a credit card or a debit card.

Preferably, the method processes loyalty identification and payment as part of a single transaction.

In accordance with the invention, there is also provided a system for making a payment and loyalty transaction for goods and/or services being purchased by a consumer from a merchant, including:
(a) a mobile computing device, including one or more computer processors in communication with a display, user input devices and non-transitory computer readable data storage, including stored thereon computer readable instructions;
(b) a merchant point of sale (POS) system in communication with the mobile computing device;
wherein the computer readable instructions, when executed by the one or more processors, cause the device to perform the steps of:
(a) generating a list of registered loyalty programs and receiving a consumer selection of one of said loyalty programs;
(b) generating a list of registered payment cards and receiving a consumer selection of one of said payment cards;
(c) sending payment data to the merchant's point of sale (POS) system including:
   (i) data representing said one of the selected loyalty programs; and
   (ii) data representing said one of the selected payment cards;
(d) receiving payment transaction data from the merchant POS system including:
   (i) data representing that the payment transaction was completed; and
   (ii) data representing loyalty points earned from said one of the selected loyalty programs as a result of the completed payment transaction;
(e) generating data for display on the device, including:
   (i) data representing that the payment transaction was completed; and
   (ii) data representing loyalty points earned from said one of the selected loyalty programs as a result of the completed payment transaction.

Preferably, the step of sending payment data to the merchant's POS system is effected using near-field communication protocols.

In accordance with the invention, there is also provided, a system for making a payment and loyalty transaction for goods and/or services being purchased by a consumer from a merchant, including:
(a) a mobile computing device, including one or more computer processors in communication with a display, user input devices and non-transitory computer readable data storage, including stored thereon computer readable instructions;
(b) a merchant point of sale (POS) system in communication with the mobile computing device;
(c) a digital wallet provider system; and
(d) a digital wallet provider loyalty database including a plurality of primary account numbers associated with one or more loyalty account numbers,
wherein the computer readable instructions, when executed by the one or more processors, cause the device to perform the steps of:
(a) generating a list of registered payment cards and receiving a consumer selection of one of said payment cards;
(b) sending payment data to the merchant's point of sale (POS) system including data representing said one of the selected payment cards;
(c) receiving payment transaction data from the merchant POS system including:
   (i) data representing that the payment transaction was completed; and
   (ii) data representing loyalty points earned from said payment transaction with said one or more loyalty accounts;
(e) generating data for display on the device, including:
   (i) data representing that the payment transaction was completed; and
   (ii) data representing loyalty points earned from said payment transaction with said one or more loyalty accounts.

The system links loyalty program membership details to a payment card number (or any other card via Digital wallet such as MasterPass) and have loyalty program identification submitted to the merchant within the payment transaction rather than the customer having to carry a loyalty card, scan it at the point of sale and then provide credit/debit card for payment. This provides a single, seamless experience that includes loyalty identification and payment within a single action.

In addition, communicate the number of loyalty points that were earned within an Issuer and/or Merchant loyalty program at the completion of a transaction via the Confirmation screen on a mobile wallet or via push notification on mobile device so that a customer is informed of their loyalty program benefit immediately after the transaction is completed.

The above method and system advantageously makes everyday payments simpler, faster and more convenient.

### BRIEF DESCRIPTION OF THE DRAWINGS

Preferred embodiments of the present invention are hereafter described, by way of non-limiting example only, with reference to the accompanying drawing in which:

FIG. 1 is a schematic diagram of a system for allowing customers or merchants to process loyalty identification and payment as part of a single transaction;

FIG. 2 is a block diagram of a mobile computer device of the system shown in FIG. 1;

FIG. 3 is a flow diagram showing steps performed by a digital wallet application being executed by the mobile computer device of the system shown in FIG. 1;

FIG. 4 is an image of an exemplary embodiment of the mobile computer device shown in FIG. 1;

FIG. 5 is a flow diagram showing an onboarding process of the digital wallet application process shown in FIG. 3;

FIG. 6 is a flow diagram showing interoperation of the components of the system to execute an onboarding process;

FIG. 7 is an image of an exemplary GUIs generated by the digital wallet application;

FIG. 8 is a flow diagram showing interoperation of the components of the system to execute a view points balance process;

FIG. 9 is an image of an exemplary GUIs generated by the digital wallet application;

FIG. 10 is a flow diagram showing a transaction process of the digital wallet application process shown in FIG. 3;

FIG. 11 is a flow diagram showing interoperation of the components of the system to execute a transaction process;

FIG. 12 is an image of the mobile computer device shown in FIG. 1 in a condition of use; and

FIG. 13 is an image of the mobile computer device shown in FIG. 1 in another condition of use.

### DETAILED DESCRIPTION OF PREFERRED EMBODIMENTS OF THE INVENTION

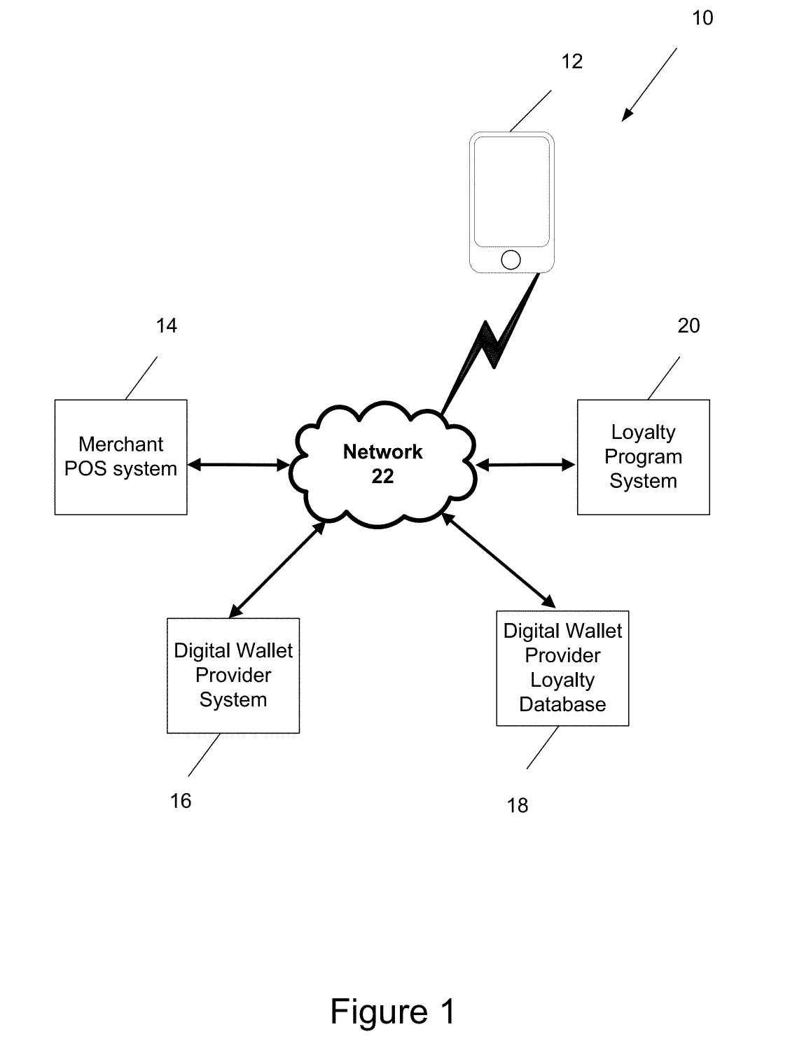

The system 10 shown in FIG. 1 allows customers or merchants to process loyalty identification and payment as part of a single transaction. The system 10 includes:
(a) a mobile computer device 12;
(b) a merchant point of sale (POS) system 14;
(c) a digital wallet provider system 16;
(d) a digital wallet provider loyalty database 18; and
(e) a third party loyalty program system 20.

The components of the system 10 are in communication via the network 22. The communications network 22 may include the Internet, telecommunications networks and/or local area networks.

The system 10 makes everyday payments simpler, faster and more convenient. The system 10 removes the hassle of carrying, retrieving and scanning the loyalty card at the point of sale. The purchaser gets the additional positive emotional engagement at the time of payment when they see how many points they earned as part of the transaction.

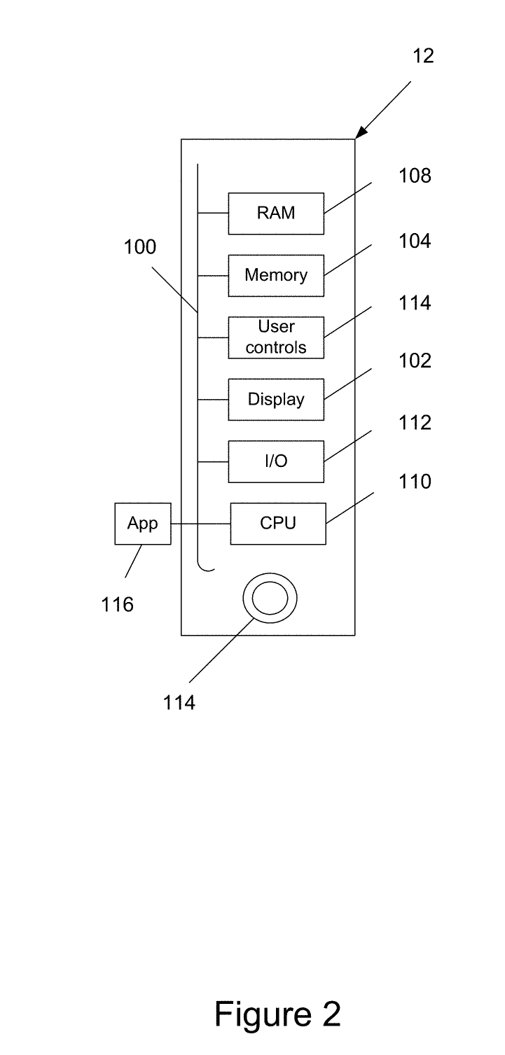

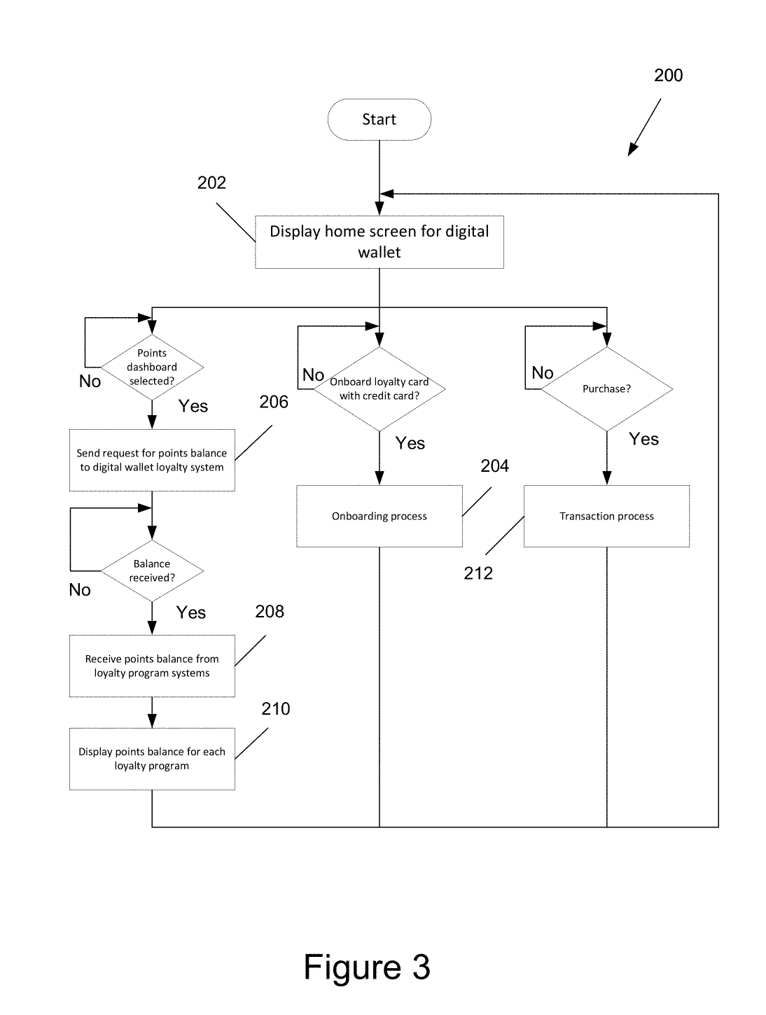

FIG. 2 is a block diagram showing an exemplary device 12 in which embodiments of the invention may be practiced. The device 12 is preferably a mobile computer device such as a smart phone, a personal data assistant (PDA), a palm-top computer, and multimedia Internet enabled cellular telephones. For ease of description, the device 12 is below described, by way of non-limiting example, with reference to a mobile device in the form of am iPhone, such as the one shown in FIG. 3, or one manufactured by LG™, HTC™ and Samsung, for example.

As shown, the device 100 includes the following components in electronic communication via a bus 100:

1. a display 102;
2. non-volatile (non-transitory) memory 104;
3. random access memory (“RAM”) 108;
4. N processing components 110;
5. a transceiver component 112 that includes N transceivers; and
6. user controls 114.

Although the components depicted in FIG. 2 represent physical components, FIG. 2 is not intended to be a hardware diagram. Thus, many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 102 generally operates to provide a presentation of content to a user, and may be realized by any of a variety of displays (e.g., CRT, LCD, HDMI, micro-projector and OLED displays). In general, the non-volatile data storage 104 (also referred to as non-volatile memory) functions to store (e.g., persistently store) data and executable code including code that is associated with the functional components of a digital Wallet Application 116 that executes the processes 200 set out in FIG. 3.

In some embodiments for example, the non-volatile memory 104 includes bootloader code, modem software, operating system code, file system code, and code to facilitate the implementation of one or more portions of the Digital Wallet Application 116 as well as other components, well known to those of ordinary skill in the art, that are not depicted nor described for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The transceiver components 112 are also adapted to effect contact less payments with the merchant POS system 14. For example, the transceiver components are able to effect contactless payment using Near-Field Communications (NFC) by way of Apple Pay™, or MasterPass™, for example.

It should be recognized that FIG. 2 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 104. Non-transitory computer-readable media 104 includes both computer storage media and communication media including any medium that facilitates transfer of a computer program from one place to another. A storage media may be any available media that can be accessed by a computer.

The merchant POS system 14 is preferably any know POS system that can be used to effect a credit card payment. Preferably, the POS system 14 can facilitate contactless payments using NFC by way of Apple Pay™, or MasterPass™, for example.

The digital wallet provider system 16 is preferably an existing system that can interface between the merchant POS system 14 and the digital wallet loyalty database. For example, the digital wallet provider system 16 includes the existing MasterPass™ payment processes.

The digital wallet provider loyalty database 18 is, for example, a MasterPass™ Loyalty database includes all business logic including:
(a) Linking multiple primary account numbers (PANs) with multiple loyalty numbers;
(b) Application Program Interface's (API's) connecting with the 3rd party loyalty program system 20 to retrieve points balances;
(c) Matching of PAN at time of payment with a registered loyalty account so that points balance can be retrieved for display to the customer and loyalty identification number can be surfaced to the merchant within the payment confirmation response;
(d) Management of Earn rates for 3rd party loyalty programs so that points earned values can be communicated to the customer at the time of the transaction; and
(e) Provision of loyalty transaction details to the 3rd party loyalty provider 20 on behalf of the merchant (this is outlined within Option 2 in the process flow)

The system 10 manages provision of loyalty identification to merchants to allocate points based on business logic defined within the Loyalty database 18.

Digital Wallet Application 116

The interoperation of the components of the system 10 are hereafter described, by way of non limiting example, with reference to the Digital Wallet Application (DW App) 116 being executed on the user's device 12. The DW App 116 can be used with payment cards including credit cards, debit cards, store cards, etc. For ease of description, the DW App 116 is below described by way of reference to credit cards only. However, the DW App 116 and the system 10 can be used with any suitable payment card.

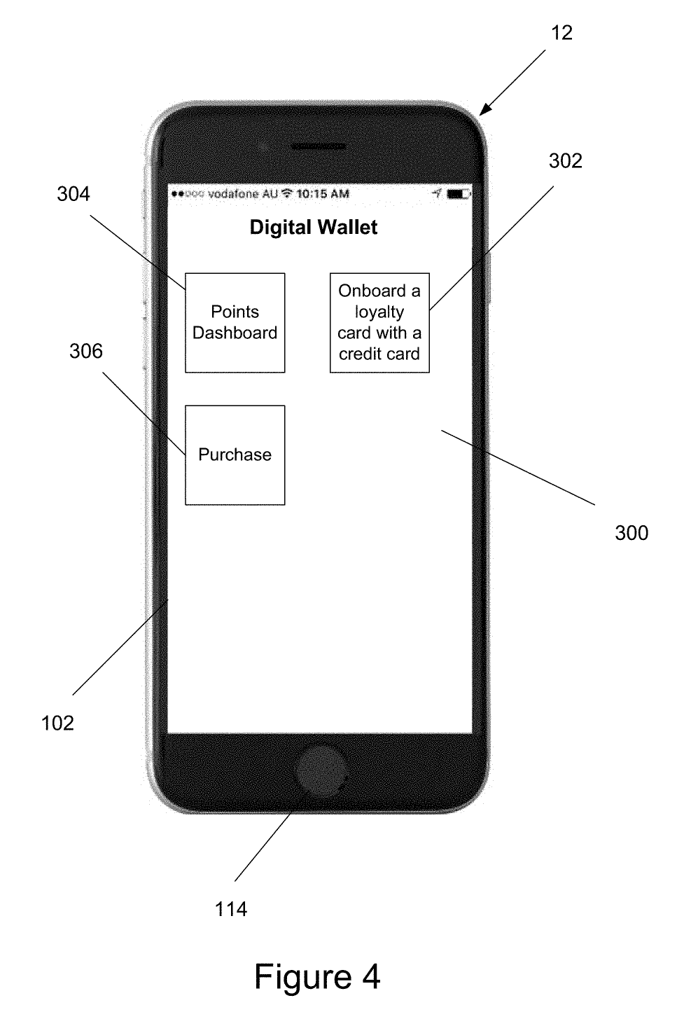

With reference to FIG. 3, the mobile device 12 executes the Digital Wallet Application 116 by performing the steps 200, including, on execution of the Digital Wallet Icon (not shown), generating, at step 202, the “Home” graphical user interface (GUI) 300 shown in FIG. 4 on the display 102 of the device 12. The Home GUI 300 includes the following function buttons:
(a) Onboard Loyalty Card with Credit Card 302;
(b) Points Dashboard 304; and
(c) Purchase 306.

The operations performed by the system when each one of the above function button buttons are selected by the user are set out below in further detail.

(a) Onboard Loyalty Card with Credit Card 302

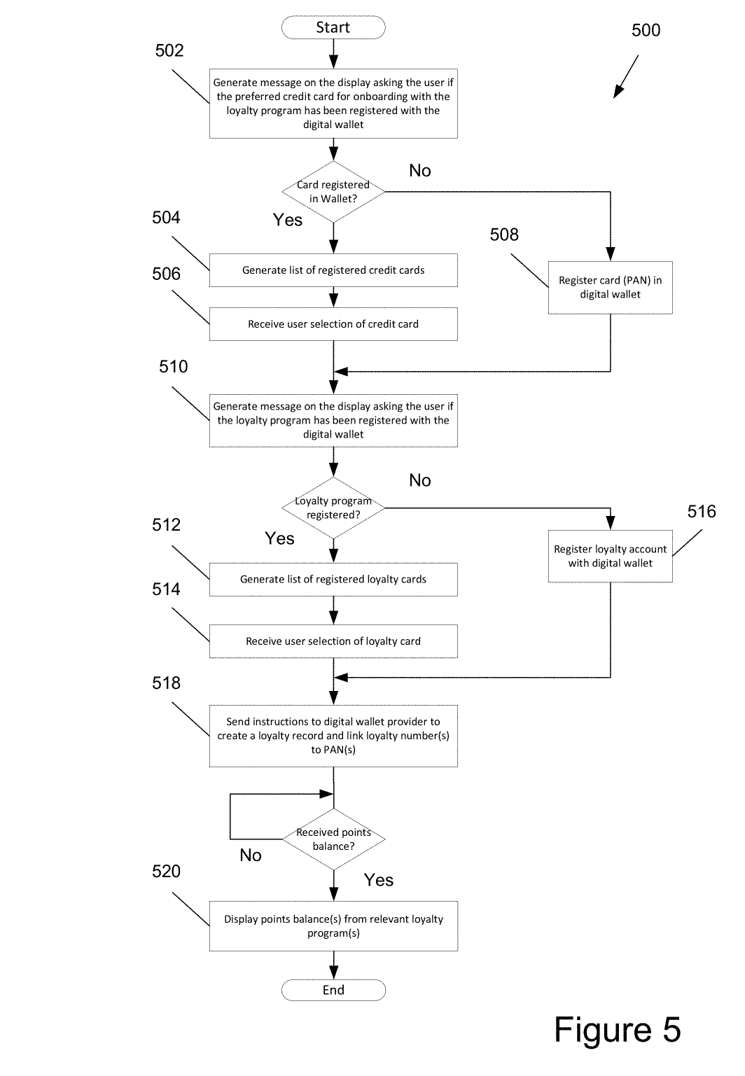

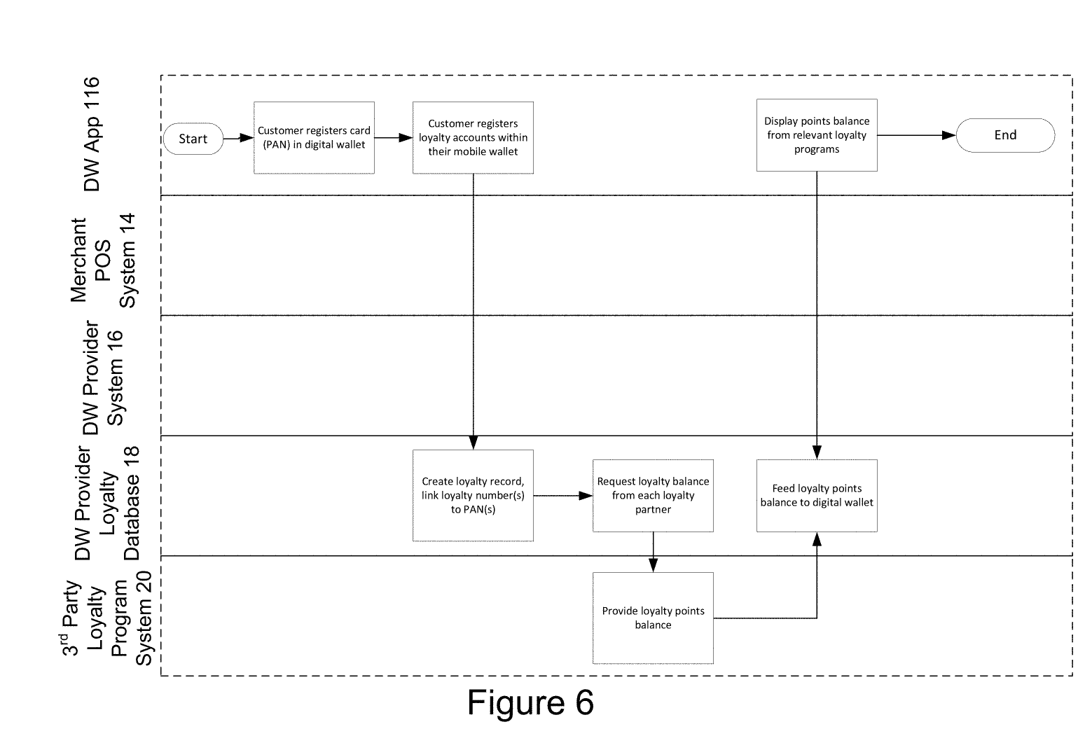

If a user selects the “Onboard a loyalty card with a credit card” function button 302, then the DW App 116 executes, at step 204, the onboarding process 500 shown in FIG. 5 which calls up the services of the other components of the system 10 in the manner shown in FIG. 6.

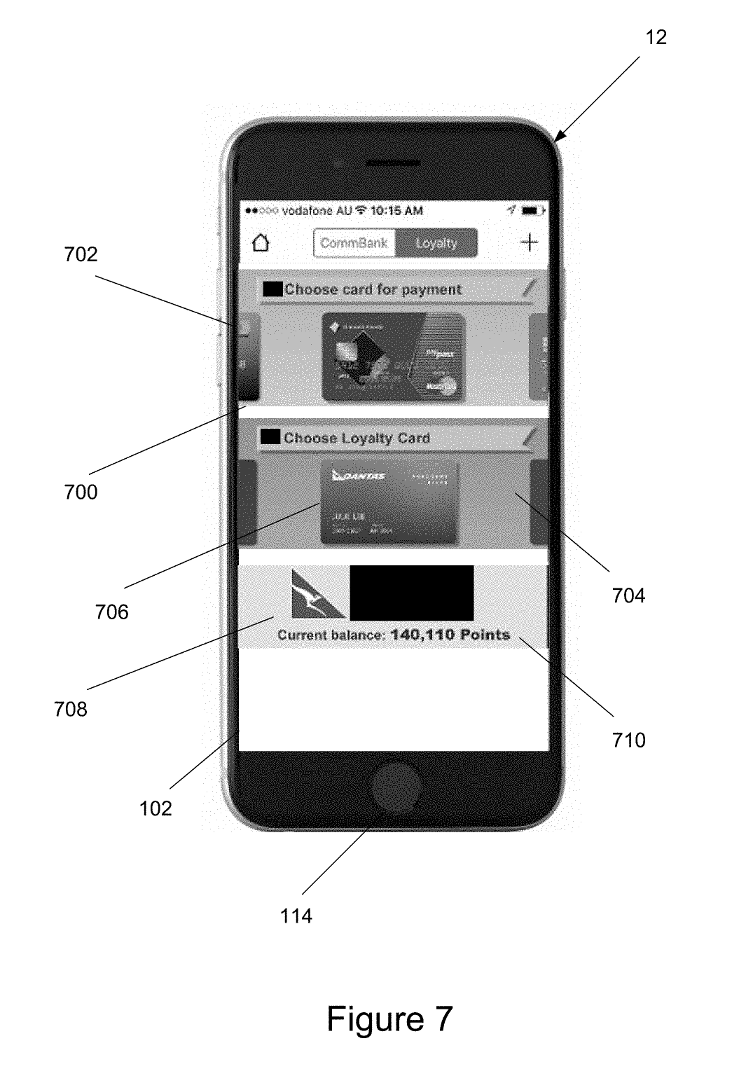

At step 502, the DW App 116 generates a message on the display 102 of the device 12 asking the user if the preferred credit card for onboarding with the loyalty program has been registered with the digital wallet. If the user confirms that this is the case, then the DW App 116 generates, at step 504, a Credit Card Selection GUI 700 shown in FIG. 7 that includes a list of registered credit cards 702. At step 506, the DW App 116 receives the user selection of the registered credit card 702 to be onboarded.

Alternatively, if the preferred credit card for onboarding with the loyalty program has not been registered with the digital wallet, then the DW App registers, at step 508, the card primary account number (PAN) in the digital wallet. This process is known in the art and is not described here in further detail.

At step 510, the DW App 116 generates a message on the display 102 of the device 12 asking the user if the preferred loyalty program for onboarding has been registered with the digital wallet. If the user confirms that this is the case, then the DW App 116 generates, at step 512, a Loyalty Card Selection GUI 704 shown in FIG. 7 that includes a list of registered loyalty cards 706. At step 514, the DW App 116 receives the user selection of the registered loyalty card 706 to be onboarded.

Alternatively, if the preferred loyalty card for onboarding with the loyalty program has not been registered with the digital wallet, then the DW App registers, at step 516, the loyalty account number with the digital wallet. This process is known in the art and is not described here in further detail.

The DW App 116 then sends, at step 518, an instruction to the DW Provider Loyalty Database 18 to:
(a) create a loyalty record for the onboarded loyalty card and the credit card; and
(b) link the loyalty number to the PAN of the credit card selected for on boarding.

As particularly shown in FIG. 6, the DW Provider Loyalty Database 18 performs the above described steps and then sends a request to the relevant third party loyalty program system 20 to provide the balance of points. On receipt of this request, the third party loyalty program system 20 provides the balance of points back to the DW Provider Loyalty Database 18. The DW Provider Loyalty Database 18 receive the points balance from the third party loyalty program system 20 and passes the data back to the DW App 116 being executed on the device 12.

On receipt of the points balance from the DW Provider Loyalty Database 18, the DW App 116 generates a Points GUI 408 displays, at step 520, the points balance 710 for the now onboarded loyalty card 706 in the manner shown in FIG. 7.

### (b) Points Dashboard 304

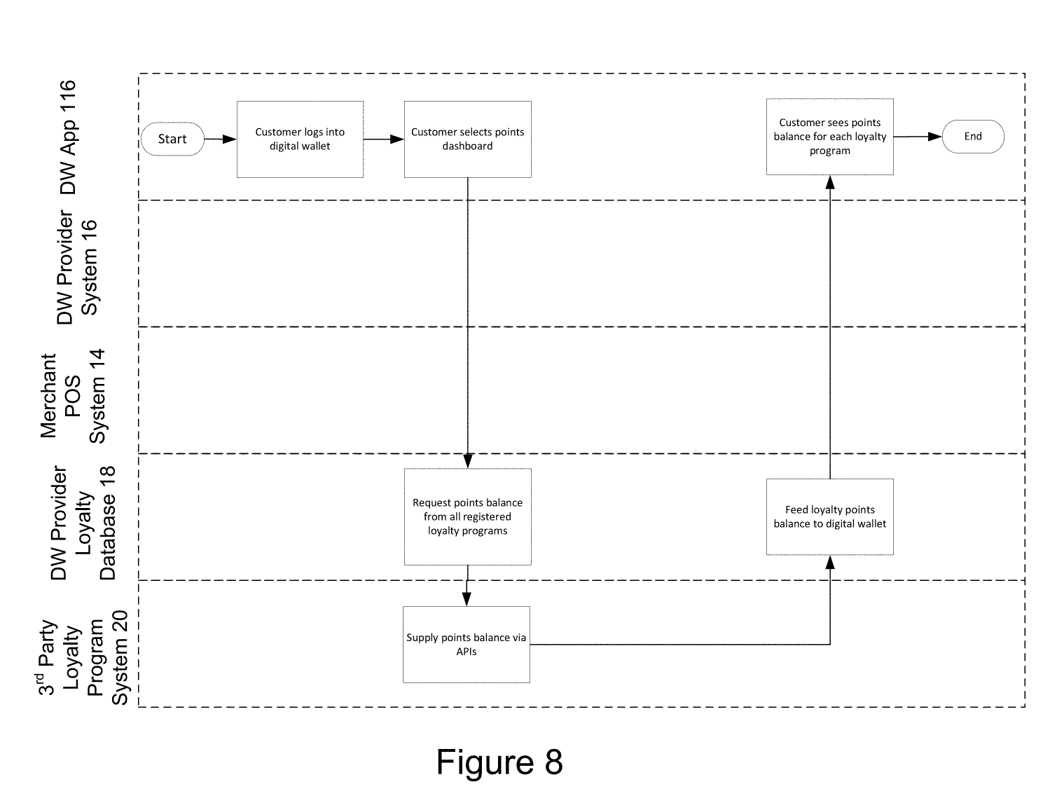

If the user selects the “Points Balance” function button 304, then the DW App 116 sends, at step 206, a request to the DW Provider Loyalty Database 18 to fetch the points balance for all registered loyalty cards. In doing so, the DW App 116 calls up the services of the other components of the system 10 in the manner shown in FIG. 8.

As particularly shown in FIG. 8, the DW Provider Loyalty Database 18 receives the request from the DW App 116 and then sends a request to the relevant third party loyalty program systems 20 to provide the balances of points. On receipt of this request, the relevant third party loyalty program systems 20 provide the balances of points back to the DW Provider Loyalty Database 18. The DW Provider Loyalty Database 18 receives the points balances from all relevant the third party loyalty program systems 20 and passes the data back to the DW App 116 being executed on the device 12.

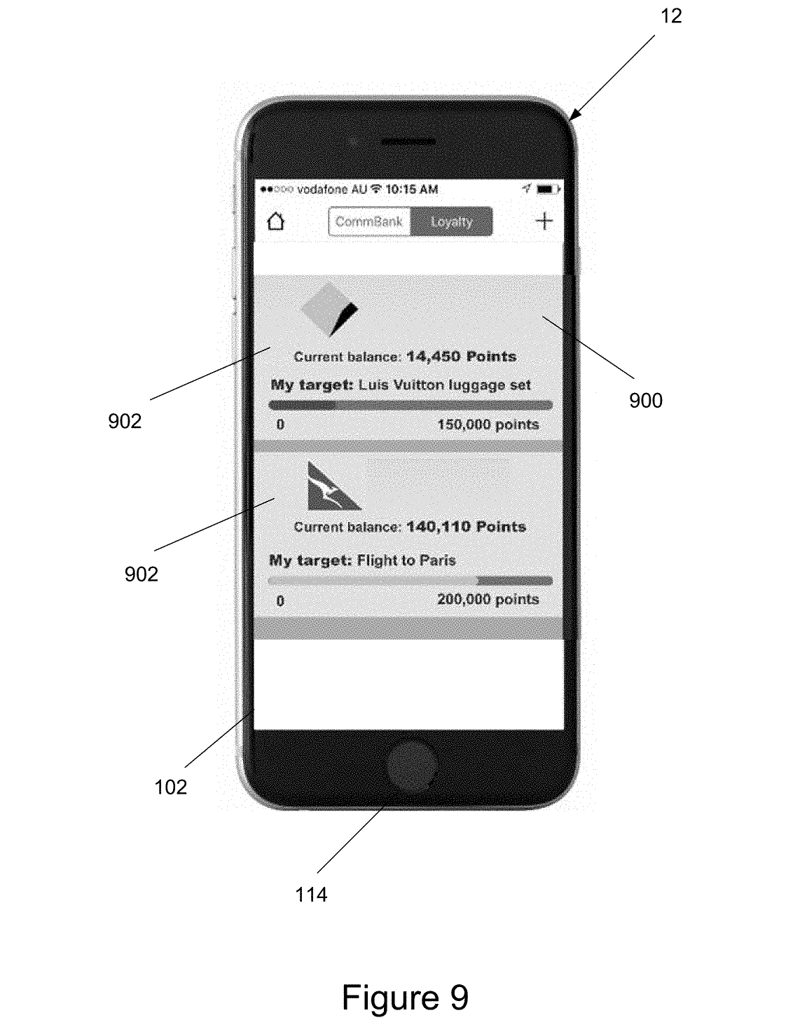

On receipt of the points balance from the DW Provider Loyalty Database 18, at step 208, the DW App 116 generates a Points Dashboard GUI 900 and displays, at step 210, the points balance 902 for each relevant loyalty card in the manner shown in FIG. 9.

### (c) Purchase Goods or Services 306

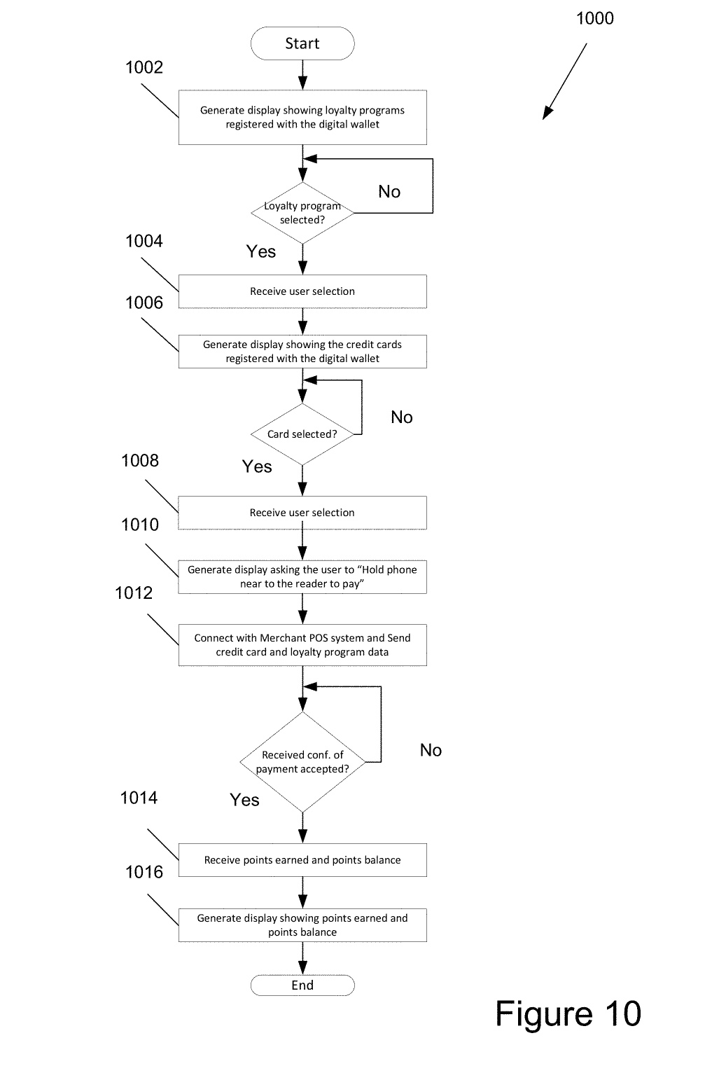

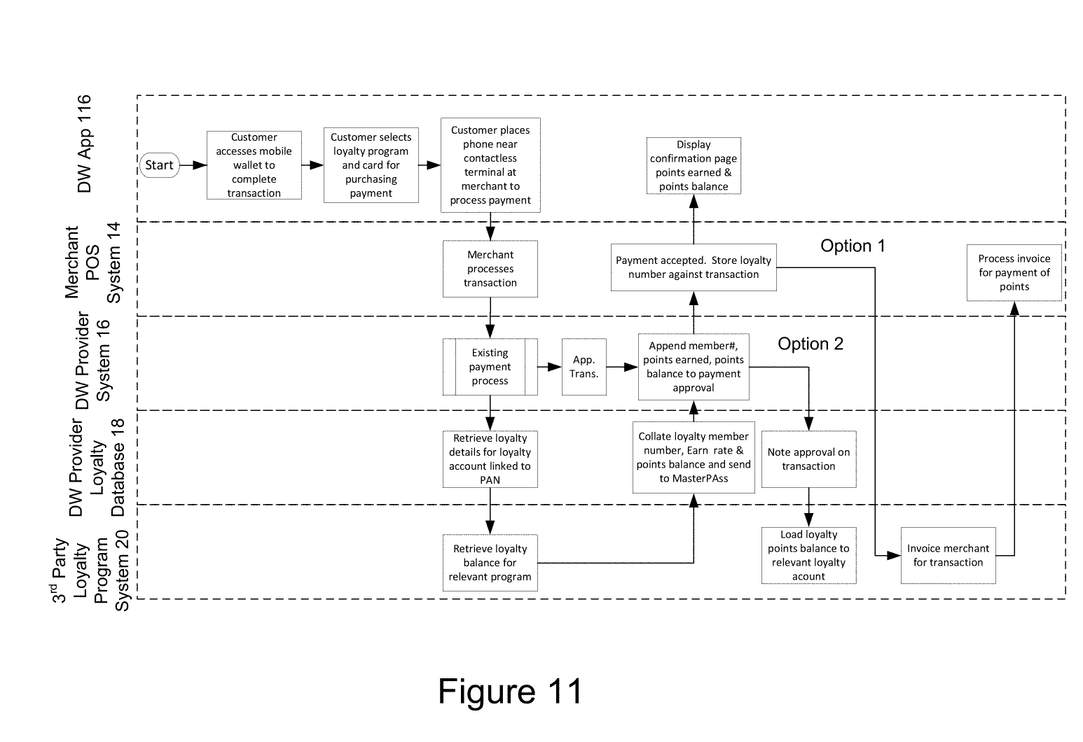

If the user selects the “Purchase” function button 30, then the DW App 116 executes, at step 212, the Purchase process 1000 shown in FIG. 10 which calls up the services of the other components of the system 10 in the manner shown in FIG. 11.

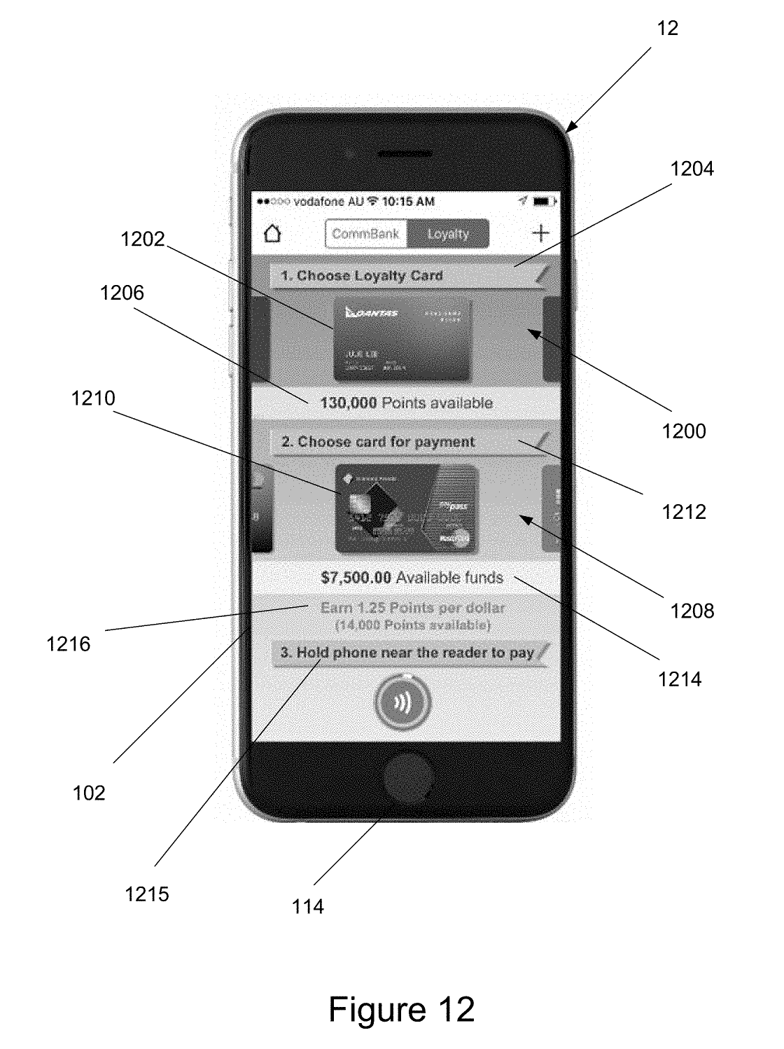

At step 1002, the DW App 116 generates the Loyalty Card Selection GUI 1200 shown in FIG. 12 which includes a list of registered loyalty cards 1202. The Loyalty Card GUI 1202 includes a text box 1204 asking the user to select a loyalty card. Advantageously, the Loyalty Card Selection GUI 1200 also includes the points balance 1206 for the loyalty card 1202 presented.

On receipt of a loyalty card selected by the user (the Selected Loyalty Card), at step 1004, the DW App 116 generates, at step 1006, the Credit Card Selection GUI 1208 shown in FIG. 12 that includes a list of registered credit cards 1210. The Credit Card GUI 1208 includes a text box 1212 asking the user to select a credit card. Advantageously, the Credit Card Selection GUI 1208 also includes the available funds 1214 and the rate of points earned for the credit card 1210 presented.

On receipt of the Credit Card selected by the user (the Selected Credit Card), at step 1008, the DW App 116 generates, at step 1010, the following message 1215 on the Credit Card GUI 1208:
“Hold phone near to the reader to pay”

At step 1012, the DW App 116 forms a connection with the Merchant POS system 14 using NFC systems with ApplePay™ or MasterPass™ and sends the transaction details to the Merchant POS system 14. The transaction details include the details of the Selected Loyalty Card and the details of the Selected Credit Card.

Alternatively, the user is not required to select loyalty card. Rather, simply selecting the credit card is sufficient because the loyalty program has previously been on boarded by the user and the system 10 will be able to determine the default loyalty program. In this scenario, the transaction details only include the details of the Selected Credit Card.

As particularly shown in FIG. 11, the Merchant POS system 14 processes the transaction. These processes are known in the art and art not described here in further detail. The Merchant POS system 14 sends the transaction data, including the transaction (I.e. the details of the Selected Loyalty Card and the details of the Selected Credit Card) to the DW Provider System 16.

The DW Provider System 16 executes an existing digital wallet payment process and engages the DW Provider Loyalty database 18 to retrieve loyalty details of the loyalty account linked to the PAN. In doing so, the DW Provider Loyalty database 18 engages the third party Loyalty Program system 20 to retrieve loyalty balance for the relevant program and return with the data. On receipt of this data, the DW Provider Loyalty database 18 collates the following:
(a) loyalty member number;
(b) earn rate; and
(c) points balance.

The DW Provider Loyalty Database 18 passes this data back to the DW Provider System 16 which, on confirmation of approval of the transaction, appends the following to the payment approval:
(a) the member number;
(b) points earned; and
(c) points balance.

The DW Provider System 16 then sends an message to the Merchant POS system 14 with “Payment Accepted”. The Merchant POS System 14 received the message and stores the loyalty number against the transaction.

The Merchant POS system 14 sends the user device 12 a message to confirm that the payment has been approved.

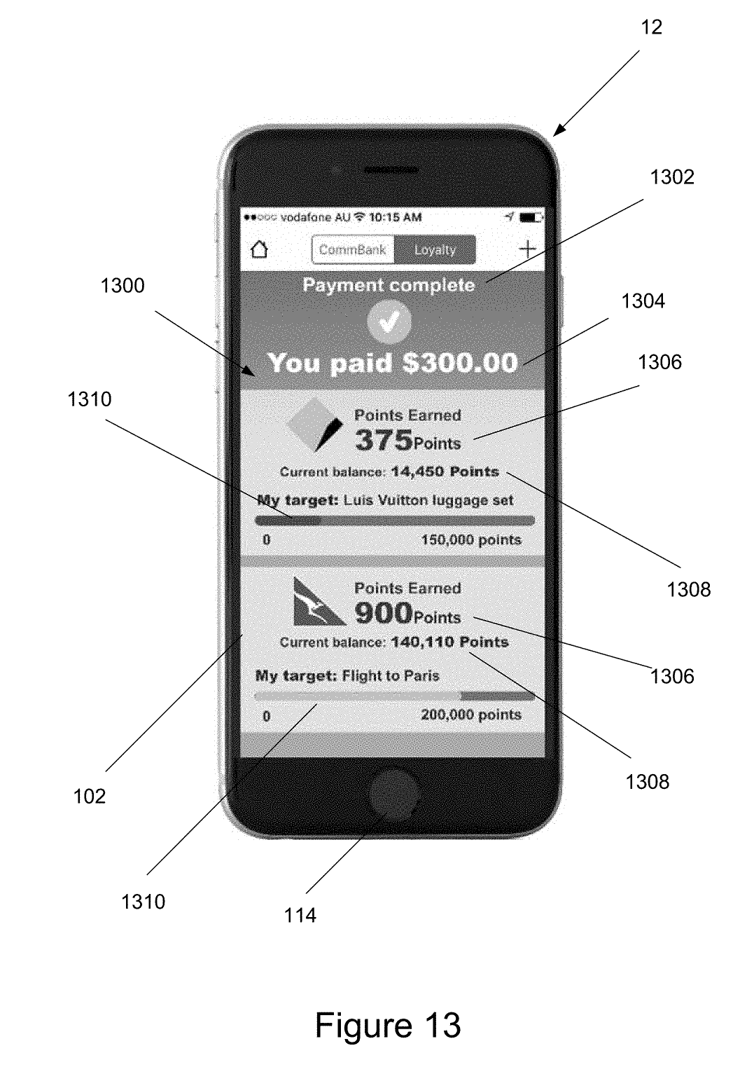

As shown in FIG. 10, the DW App 116 receives, at step 1014, a transaction approved message along with the points earned and the points balance. The DW App 116 then generates the Payment Complete GUI 1300 shown in FIG. 13 that includes:
(a) a message 1302 stating that the payment has been completed;
(b) a message 1304 stating the amount paid; and
(c) for each relevant loyalty program involved in the transaction:
   (i) Points earned 1306;
   (ii) Current points balance 1308; and
   (iii) Target points for desired good or service 1310.

Optionally, the Merchant POS System 14 can send a request to the Third Party Loyalty Program System 20 to invoice the merchant for the payment of points.

Optionally, the DW Provider System 16 can send a request to the DW Provider Loyalty Database 18 to record the approval on the transaction. In turn, DW Provider Loyalty Database 18 records the change and then sends a request to the Third Party Loyalty Program System 20 to load the points balance to the relevant loyalty account.

The system 10 supports the growth of the loyalty business by providing loyalty services that are not easily replicated or perhaps impossible to implement for our competitors in the loyalty space. The system 10 ties in with the existing Digital Wallets, such as MasterPass™, particularly contactless payments by providing an additional feature to encourage “digital first” for customers.

Another area of opportunity may be to expand this capability beyond digital payments to include physical card payments to automatically allocate points to loyalty programs for using a physical card that is linked to a loyalty program. Real time notification of points earned/updated points balance could be made possible via push notifications from the customer's Internet Banking, Digital Wallet application.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A method of making a payment and loyalty transaction for goods and/or services being purchased by a consumer from a merchant, the method being executed by one or more processors of a mobile computer device in communication with data storage, a display and input devices, including the steps of:
(a) generating a list of registered loyalty programs and receiving a consumer selection of one of said loyalty programs;
(b) generating a list of registered payment cards and receiving a consumer selection of one of said payment cards;
(c) sending payment data to the merchant's point of sale (POS) system including:
(i) data representing said one of the selected loyalty programs; and
(ii) data representing said one of the selected payment cards;
(d) receiving payment transaction data from the merchant POS system including:
(i) data representing that the payment transaction was completed; and
(ii) data representing loyalty points earned from said one of the selected loyalty programs as a result of the completed payment transaction;
(e) generating data for display on the device, including:
(i) data representing that the payment transaction was completed; and
(ii) data representing loyalty points earned from said one of the selected loyalty programs as a result of the completed payment transaction.

2. The method claimed in claim 1, wherein the payment card is a credit card or a debit card.

3. The method claimed in claim 1, wherein the data representing that the payment transaction was completed includes a number representing a monetary value of the payment transaction.

4. The method claimed in claim 1, wherein the data representing the loyalty points earned includes one or more of the following:
(a) data representing points earned;
(b) data representing current points balance; and
(c) data representing a target points balance.

5. The method claimed in claim 1, wherein:
(a) the step of receiving payment transaction data from the merchant POS system includes the step of receiving data representing loyalty points earned as a result of the completed payment transaction from other loyalty programs associated with the consumer; and
(b) the step of generating data for display on the device, includes the step of generating data representing loyalty points earned as a result of the completed payment transaction from other loyalty programs associated with the consumer.

6. The method claimed in claim 5, wherein the data representing loyalty points earned as a result of the completed payment transaction from other loyalty programs associated with the consumer, includes one or more of the following:
(a) data representing points earned;
(b) data representing current points balance; and
(c) data representing a target points balance.

7. The method claimed in claim 1, wherein the method processes loyalty identification and payment as part of a single transaction.

8. The method claimed in claim 1, wherein the step of sending payment data to the merchant's POS system is effected using near-field communication protocols.

9. A system for making a payment and loyalty transaction for goods and/or services being purchased by a consumer from a merchant, including:
(a) a mobile computing device, including one or more computer processors in communication with a display, user input devices and non-transitory computer readable data storage, including stored thereon computer readable instructions; and
(b) a merchant point of sale (POS) system in communication with the mobile computing device;
wherein the computer readable instructions, when executed by the one or more processors, cause the device to perform the steps of:
(a) generating a list of registered loyalty programs and receiving a consumer selection of one of said loyalty programs;
(b) generating a list of registered payment cards and receiving a consumer selection of one of said payment cards;
(c) sending payment data to the merchant's point of sale (POS) system including:
(i) data representing said one of the selected loyalty programs; and
(ii) data representing said one of the selected payment cards;
(d) receiving payment transaction data from the merchant POS system including:
(i) data representing that the payment transaction was completed; and
(ii) data representing loyalty points earned from said one of the selected loyalty programs as a result of the completed payment transaction;
(e) generating data for display on the device, including:
(i) data representing that the payment transaction was completed; and
(ii) data representing loyalty points earned from said one of the selected loyalty programs as a result of the completed payment transaction.

10. The system claimed in claim 9, wherein the merchant POS system is in communication with:
(a) a digital wallet provider system;
(b) a digital wallet loyalty database; and
(c) a third party loyalty program system.

11. The system claimed in claim 10, wherein the merchant POS system sends transaction data, including:
(a) data representing said one of the selected loyalty programs; and
(b) data representing said one of the selected payment cards,
to the digital Provider System which executes a digital wallet payment process and engages the digital wallet provider loyalty database to retrieve loyalty details of the loyalty account linked to the payment card.

12. The system claimed in claim 11, wherein the digital wallet provider loyalty database engages the third party loyalty program system to retrieve loyalty balance for the selected loyalty program and, on receipt of this data collates the following:
(a) loyalty member number;
(b) earn rate; and
(c) points balance.

13. The system claimed in claim 12, wherein the digital wallet provider loyalty database passes this data back to the digital wallet provider system which, on confirmation of approval of the transaction, appends the following to the payment approval:
(a) the member number;
(b) points earned; and
(c) points balance.

14. The system claimed in claim 13, wherein the digital wallet provider system then sends an message to the merchant POS system with data representing that the transaction has completed which, in turn, sends the transaction completed message to the device.

15. The system claimed in claim 9, wherein the payment card is a credit card or a debit card.

16. The system claimed in claim 9, wherein the data representing the payment transaction was completed includes a number representing a monetary value of the payment transaction.

17. The system claimed in claim 9, wherein the data representing the loyalty points earned includes one or more of the following:
(a) data representing points earned;
(b) data representing current points balance; and
(c) data representing a target points balance.

18. The system claimed in claim 9, wherein the system processes loyalty identification and payment as part of a single transaction

19. The system claimed in claim 9, wherein the step of sending payment data to the merchant's POS system is effected using near-field communication protocols.

20. A system for making a payment and loyalty transaction for goods and/or services being purchased by a consumer from a merchant, including:
(a) a mobile computing device, including one or more computer processors in communication with a display, user input devices and non-transitory computer readable data storage, including stored thereon computer readable instructions;
(b) a merchant point of sale (POS) system in communication with the mobile computing device;
(c) a digital wallet provider system; and
(d) a digital wallet provider loyalty database including a plurality of primary account numbers associated with one or more loyalty account numbers,
wherein the computer readable instructions, when executed by the one or more processors, cause the device to perform the steps of:
(a) generating a list of registered payment cards and receiving a consumer selection of one of said payment cards;
(b) sending payment data to the merchant's point of sale (POS) system including data representing said one of the selected payment cards;
(c) receiving payment transaction data from the merchant POS system including:
(i) data representing that the payment transaction was completed; and
(ii) data representing loyalty points earned from said payment transaction with said one or more loyalty accounts;
(e) generating data for display on the device, including:
(i) data representing that the payment transaction was completed; and
(ii) data representing loyalty points earned from said payment transaction with said one or more loyalty accounts.

21. The system claimed in claim 20, wherein the merchant POS system sends transaction data, including data representing said one of the selected payment cards, to the digital Provider System which executes a digital wallet payment process and engages the digital wallet provider loyalty database to retrieve loyalty details of the loyalty account linked to the payment card.

22. The system claimed in claim 21, wherein the digital wallet provider loyalty database engages a third party loyalty program system to retrieve loyalty balance for the associated loyalty program and, on receipt of this data collates the following:
(a) loyalty member number;
(b) earn rate; and
(c) points balance.

23. The system claimed in claim 22, wherein the digital wallet provider loyalty database passes this data back to the digital wallet provider system which, on confirmation of approval of the transaction, appends the following to the payment approval:
(a) the member number;
(b) points earned; and
(c) points balance.

24. The system claimed in claim 23, wherein the digital wallet provider system then sends a message to the merchant POS system with data representing that the transaction has completed which, in turn, sends the transaction completed message to the device.
